(19) United States
(12) Patent Application Publication
(10) Pub. No.: US 2014/0115443 A1
(43) Pub. Date: Apr. 24, 2014

(54) METHOD, SYSTEM, AND COMPUTER PROGRAM PRODUCT FOR GENERATING CUSTOMIZED DOCUMENTS

(71) Applicant: Docstoc, Inc., Santa Monica, CA (US)

(72) Inventors: Alon Shwartz, West Hills, CA (US); Matthew A. Neco, Santa Monica, CA (US)

(21) Appl. No.: 14/061,674

(22) Filed: Oct. 23, 2013

Related U.S. Application Data
(60) Provisional application No. 61/717,220, filed on Oct. 23, 2012.

(51) Int. Cl. G06F 17/24

(52) U.S. Cl. CPC G06F 17/24
USPC 715/234

(57) ABSTRACT

Described is a method, system, and computer program product for generating customized documents. A document template is provided, where the document template includes a place holder and a section holder. A directional graph is provided for collecting information from an end-user, where the information collected is related to the place holder and section holder of the document template for creating a customized document. Information is collected from the end-user, and a transformation engine merges the information collected from the end-user with the document template to create a customized document.

### CROSS-REFERENCE TO RELATED APPLICATIONS

This is a Non-Provisional Application of U.S. Provisional Application No. 61/717,220, filed on Oct. 23, 2012, entitled, “Method and Apparatus for Automatic. Document Generation.”

### FIELD OF INVENTION

The present invention relates to the field of automated document generation and, more particularly, to a mechanism for the flexible automated creation of highly customized documents to suit a wide variety of end-users.

### BACKGROUND OF INVENTION

The generation of documents has typically been a complicated manual task involving the labor of a number of people. In particular, the generation of professional documents(e.g., legal documents, contracts, wills, trusts, business documents, and the like) has required the expense and participation of a number of professionals and has been beyond the ability of automation. When automation has been attempted, it has generally required a custom application or a special-purpose system that is not available to the majority of users.

One existing technique is to use HTML or XML coding to define fields and other decision trees that can be used to build a document. Such techniques require substantial knowledge of coding and prevent those who understand the document best from being closely involved with the generation of a document.

Thus, a continuing need exists for a system that allows for the automatic generation of customized documents that is easy to use and is accessible to a wide audience of end-users. The present invention solves this need as described in the sections below.

SUMMARY OF THE INVENTION

In one aspect, the present invention provides a method for creating customized documents. The method includes an act of providing a document template where the document template includes a place holder and a section holder. In an additional act, the method comprises providing a directional graph with nodes for collecting information from an end-user, where the information collected is related to the place holder and section holder of the document template for creating a customized document. In vet another act, the method comprises collecting information from an end-user. In still another act, a transformation engine is used for merging information collected from an end-user with the document template to create a customized document.

In another aspect, the nodes of the graph are generated to perform logical actions in response to information collected from the end-user.

In still another aspect, the logical actions are selected from a group consisting of filling place holders, adding sections, removing sections, presenting further information queries, modifying a user interaction level, providing recommendations to the end-user, providing tips to the end-user, providing information to the end-user, and presenting the end-user with a transaction opportunity.

In yet another aspect, the farther Information is selected from a group consisting of detailed descriptions, questions, and options, and is in a format selected from a group consisting of text, audio, and video.

In a further aspect, the method comprises a further act of storing a set of information collected from the end-user and mapping the information to another directional graph for merging with another document template; whereby the efficiency, accuracy, and consistency of a user's creation of customized documents is enhanced.

In a still further aspect, information is collected from multiple end-users and is merged with the document template to create a collaborative customized document.

In a yet further aspect, the method further comprises an act of providing an administrative end-user with an ability to grant access privileges, where the administrative end-user determines a degree of access for other end-users.

In another aspect, end-users may communicate with other end users by providing, comments accessible to other end users.

In still another aspect, the degree of access for other end-users is determined by limiting the other end-user's access to portions of the document template, portions of the directional graph, what information is collected from the other end-user, contextual information presented to the other end-user, and comments from other end-users.

In yet another aspect, the method comprise a further act of, based on a portion of the information collected from the end-user, determining a complexity level for collecting other information from the end-user.

In a further aspect, the complexity level for collecting other information from the end user is determined in a manner selected from a group consisting of explicit selection of the complexity level by the end-user, automatic selection of the complexity level based on information collected from the end-user, and explicit selection of the complexity level by another end-user.

In a still further aspect, at least one of the place holder and section holder of the document template contains another place holder or section holder

In a yet further aspect, the invention further comprises an act of storing a set of information collected from the end-user as a user profile and mapping the information from the user profile to the directional graph for merging the document template; whereby the efficiency, accuracy, and consistency of a user's creation of Customized documents is enhanced.

In another aspect, the transformation engine is configured to merge the information collected from the end-user with multiple document templates to create multiple customized documents.

In yet another aspect, the document template is a multimedia document template and the customized document is a multimedia document.

In a further aspect, the method comprises an act of, based on a portion of the information collected from the end-user, determining a complexity level for the customized document.

In a still further aspect, the transformation engine is configured to merge the information collected from the end-user with multiple document templates to create multiple customized documents.

In another aspect, the method farther comprises an act of, based on a portion of the information collected from the end-user, determining a complexity level for the customized document, and where the end-user can toggle between various levels of complexity.

in still another aspect, the present invention provides a method for automating the creation of customized documents. The method includes an act of generating a document template where the document template includes a place holder and a section holder. In an additional act, the method comprises generating a directional graph with nodes for collecting information from an end-user, where the information collected is related to the place holder and section holder of the document template for creating a customized document. In yet another act, the method comprises collecting, information from an end-user. In still another act, a transformation engine is generated for merging information collected from an end-user with the document template to create a customized document.

in a further aspect, the various operations and aspects above are incorporated into computer-readable instructions executed on a data processing system having a processor and memory in order to create a system for creating customized documents.

In a yet further aspect, the various operations and aspects above are incorporated into computer-readable instructions stored on a computer-readable medium to provide a computer program product for creating customized documents.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a data processing system according to the principles of the present invention;

FIG. 2 is an illustration of a computer program product according to the principles of the present invention;

FIG. 3 is an illustration of an example interface according to the principles of the present invention;

FIG. 4 is a flow diagram illustrating actions of a creator for creating a dynamic document according to the principles of the present invention;

FIG. 5 is an illustration of an expanded view of a wizard editor according to the principles of the present invention;

FIG. 6 is an illustration of a wizard editor with a document section expanded according to the principles of the present invention;

FIG. 7 is an illustration of expansion of placeholders of the wizard editor according, to the principles of the present invention;

FIG. 8 is an illustration of creation and defining of a placeholder according to the principles of the present invention;

FIG. 9 is an illustration of a dialog box for defining of a question or option choice by a creator according to the principles of the present invention;

FIG. 10 is an illustration of nesting of sections into other sections according to the principles of the present invention;

FIG. 11 is an illustration of a preview window that allows a creator to review a questions and options flow that has been defined according to the principles of the present invention;

FIG. 12 is a flow diagram illustrating operation of a simple document creation according to the principles of the present invention;

FIG. 13 is a flow diagram illustrating how an end-user would use a template according to the principles of the present invention;

FIG. 14 is an illustration of a preview window showing an example of a Help Tooltip according to the principles of the present invention; and

FIG. 15 is an illustration of a preview window showing an example of a Help Tooltip applied to an answer or option according to the principles of the present invention.

### DETAILED DESCRIPTION

The present invention relates to the field of automated document generation and, more particularly, to a mechanism for the flexible automated creation of highly customized documents to suit a wide variety of end-users. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments' presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of various principal aspects of the present invention is provided, Subsequently specific details of the present invention are provided to give an understanding of the specific aspects,

(1) Principal Aspects

The present invention has three “principal” aspects. The first is a method for creating customized documents, typically in the form of software, operating within a data processing system, for receiving user input and, based on the user input, generating a customized document. The second principal aspect is a data processing system having a memory, a processor, and a set of instructions fir causing the memory and processor to produce a customized document based on information received from an end-user. The third principal aspect is a computer program product. The computer program product generally represents computer-readable instructions stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories, These aspects will be described in further detail below.

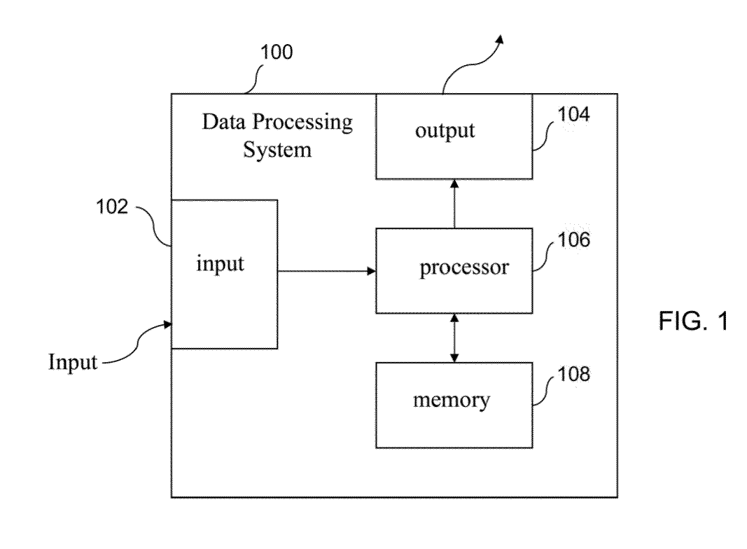

A block diagram depicting the components of a general-purpose data processing system for use in conjunction with the present invention is provided in FIG. 1. The system 100 comprises an input 102 for receiving information from the user, The input 102 typically includes multiple “ports,” to allow for user input of information into the system. An output 104 is connected with the processor for sending information to a display for the user, as well as, to other output devices or other programs; e.g., to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software that are to be manipulated by commands to the processor 106.

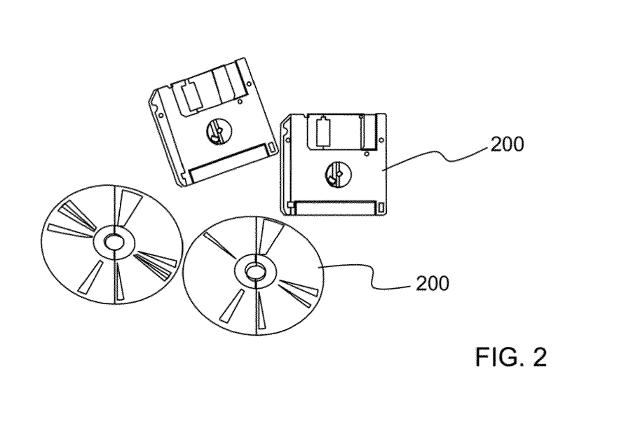

An illustrative diagram of a computer program product embodying the present invention is depicted in FIG. 2. The computer program product 200 is depicted as an optical disk such as a CD or DVD. However, as mentioned previously, the computer program product generally represents computer-readable instruction means stored on any compatible computer-readable medium. The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e., computer operations coded into a computer chip), The “instruction means” may be stored in the memory of a computer or on a computer-readable medium, non-limiting examples of which such as a hard drive, floppy disk, a CD-ROM, a thumb-drive, or a flash drive.

(2) Specific Details

(2.1) Terminology

Some specific terminology will be used to describe the method, system, and computer program product according to the principles of the present invention. These terms are used to describe the concepts that they represent to reduce any ambiguity that may result if the terms are used without such specific definitions.

A Dynamic Document, also referred to as a customized document, is a document that can take many different final forms depending on options and decisions by an end-user. As a non-limiting example, a dynamic document could be a will and testament that includes optional material based on a number of factors, such as gender of the testator, marital status, state of residence, presence or absence of children, and other factors related to such a document. A Dynamic Document is comprised of a plurality of Sections (or section holders), where the use of each Section is determined by decisions and choices made by an end-user. A Section is general in the sense that the same Section may be provided to any end-user that makes the same choices as another end-user.

However, each Section is further customizable by the use of Placeholders. A Placeholder is a location in a Section that represents data specific to an end-user, non-limiting examples of which include name, address, marital status, date. This combination of Sections and Placeholders allows the generation of highly customizable Dynamic Documents.

Questions and Options Flow, as presented to the end-user by what is referred to as the Wizard, are the definitions of questions the end-user needs to answer and options the end-user needs to select. The order of presentation of these questions and options: the grouping of these questions and options in the form of steps/pages of the Wizard/Flow; and the order of these steps/pages are presented to the end-user,

Instructions are the Questions and Options flow (Wizard), Action Logic (Rules), Tooltips, Mapped Fields, Sections, Placeholders, and Bookmarks that will allow the system to transform the answers the user provides and options the end-user selects into a final document.

Transformation is the process of taking the Instructions, the Dynamic Document, and the end-user's answers and options selected, and processing them into a final document.

Action Logic are sets of rules that determine the flow of the Questions and Options Flow; which questions and options are presented to the end-user; whether certain Sections will appear in the final document; and other changes to the final document. The logic is driven by the answers the end-user provides and options selected and allows for unlimited possibilities.

Tooltips are helpful information assigned to each question, group of questions, option choices, and each step of the Questions and Options Flow. The system supports different types of Tooltips that are geared for different user preferences from short, medium, and long detailed descriptions, questions, options and output. Tooltips can also be in the format of text, audio, and/or video guides.

Mapped Fields are types of Placeholders that can be automatically filled by the system via previously defined values the end-user entered in response to questions, or options. For example, if the end-user predefines the Placeholders: First Name, Last Name, and Address, the system will automatically fill those values in any future document the same end-user begins. The system can recognize different end-users and the data each end-user entered in the Mapped Fields is typically saved separately for each user. However, situations may arise in which documents are created in a collaborative manner by a group of end-users (which may further include sub-groups of end-users). Data for a group of end-users and for sub-groups of a group of end-users may also be stored and applied as needed in as collaborative context.

Sections are areas in the document the creator wants to apply Action Logic on, which will, therefore, result in the system showing or not showing them in the document.

A Creator is a person or persons who generate a Dynamic Document which end-users, in turn, use to create a final document. The Creator may create the base document content, define the questions and options presented to an end-user that will determine which of the plurality of Sections will be selected and will determine which Placeholders need to be included and defined for an appropriate final document.

The Creator uses an interface that allows the generation of Sections as well as a plurality of tools and presentations that help an end-user utilize the dynamic document to generate a final document. In the following description, the system is described in connection with a will and testament. However, the system is not limited to this type of document, or even to legal documents. The system has equal application to any document where answers, fields, options, location, and other metrics can impact the final form of a document, including multimedia documents.

(2.2) System and Method Overview

The present invention provides a method, system, and computer program product for defining dynamic documents through a document creation interface. The system also provides an interface for users to build a custom document by answering questions and selecting options provided by the creator of the dynamic document.

A document template is provided that includes at least one placeholder and at least one section (or section holder). A directional graph with nodes is provided for collecting information from the end-user, where the information is related to the place holder and section holder of the document template. The nodes of the graph are generated to perform logical actions in response to information collected from the end-user, such as filling place holders, adding sections, removing sections, presenting further information queries, modifying a user interaction level, providing recommendations to the end-user, providing tips (i.e., Help Tooltips) to the end-user, providing information to the end-user, and presenting the end-user with a transaction opportunity. Further information that may be queried includes detailed descriptions, questions, and options. The format of the further information my be in the form of text, audio, or video. Once the information is collected from the end-user, a transformation engine merges the information collected from the end-user with the document template to create a customized document for dynamic document). The transformation engine can also be configured to merge information collected from the end-user with multiple document templates to create multiple customized documents.

In a desired aspect, a set of information collected from the end-user is stored and mapped to another directional graph for merging with another document template, such that the efficiency, accuracy, and consistency of a user's creation of customized documents is enhanced. Furthermore, information may be collected from multiple end-users, and the collective information from the multiple end-users is merged with document template to create a collaborative customized document.

Additionally, the present invention provides an administrative end-user with an ability to grant access privileges, where the administrative end-user determines a degree of access for other end-users. End-users may communicate with other end-users by providing comments that are accessible to other end users of the customized document. The degree of access is determined by limiting the other end-user's access to portions of the document template, portions of the directional graph, what information is collected from the other end-user, contextual information presented to the other end-user, and comments from other end-users.

Based on a portion of the information collected from the end-user, a complexity level can be determined for collecting other information from the end-user. The complexity level is determined in a manner such as explicit selection of the complexity level by the end-user, automatic selection of the complexity level based on information collected from the end-user, and explicit selection of the complexity level by another end-user. In a desired aspect, the end-user can toggle between various levels of complexity.

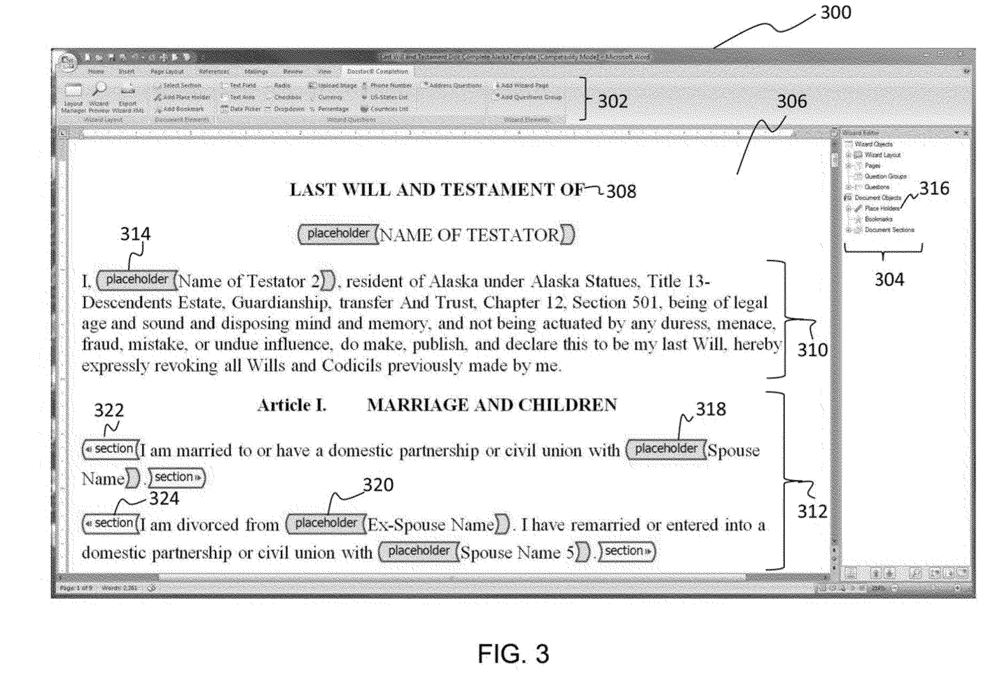

An example of the interface of one aspect of the present invention is presented in FIG. 3. The interface 300 includes a menu and command area 302, a wizard editor 304, and a document presentation section 306. The dynamic document for the non-limiting example presented in FIG. 3 is a Last Will and Testament 308. Two components of the document are visible in FIG. 3, a preamble 310 and Article I 312.

The preamble 310 includes text that is dependent on certain factors and options selected by the end-user of the document. In the example shown, the preamble 310 refers to statutes from the State of Alaska. The creator may create different preamble 310 for each state, or use features of the system to create a single preamble 310 and use placeholders to customize the preamble 310 for each state.

The preamble 310 includes a single placeholder 314 in this example. The placeholder 314:, the Name of the Testator. The placeholder 314 will insert the name of the person making the will in all sections that require the name. As the creator generates the dynamic document, the creator can simply insert an appropriate placeholder for each instance where the name is required. In one embodiment, the placeholder is represented by an indicator, often in a different color or other visual or auditor notation, and an associated plaintext name (e.g., Name of Testator) so that the creator am easily reuse the placeholder as desired.

Referring now to the wizard editor 304 shown in FIG. 3, there is a line called “PlaceHolders” 316. This line can be expanded so that all defined placeholders of the document are visible. The creator can simply drag and drop the appropriate placeholder into a section or manually enter it in the document at the appropriate place. As illustrated in FIG. 3, there are also placeholders for Spouse Name 318 and Ex-Spouse Name 320.

Using the wizard editor 304 allows the creator to see various views and relationships of the dynamic document. The different sections, placeholders, and other features of the dynamic document described herein are automatically populated in different folders and views of the documents so that the creator can easily keep track of the dynamic document.

Each placeholder is somewhat dependent on specific information provided by the end-user that will percolate through the document. Whether certain placeholders or sections will even be used is dependent on action rules, that are part of the instructions or decision tree that can be defined by the creator. For example, one section 322 of the section Article I 312 is needed when the testator is married or in a domestic partnership. If the testator is single, a different section would be present. Note that sections can be nested within other sections to create sub-sections.

Similarly, another section 324 is needed when the testator has been previously married and is divorced. If the testator had not been through a divorce, not only would the section 324 not be presented, but the placeholder 320 would not even be presented to the end-user for completion. In this case, sections 322 and 324 are used as alternatives.

The system allows the creator to define, track, and maintain a set of action rules, as part of the Instructions. Later, when an end-user is attempting to generate a document, the end-user is moved through the questions and options flow based on answers provided and options selected by the user. Different actions rules will trigger different results and/or different paths for the end-user to take.

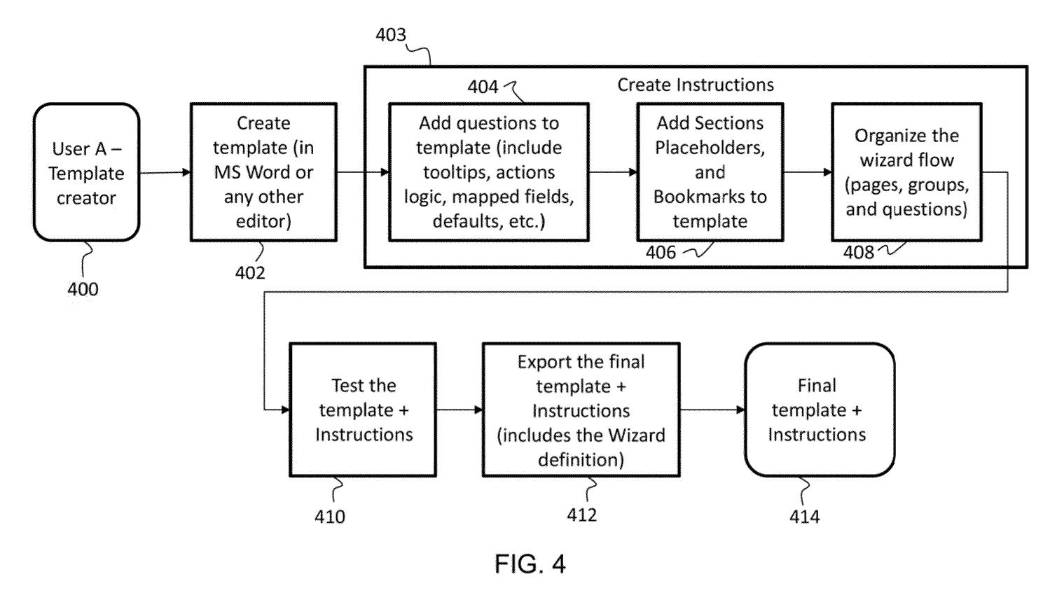

FIG. 4 is a flow diagram illustrating the actions of a creator in one aspect of the system. In a first act, a creator begins template creation 400 for a user A—template. The creator then creates a template in a document editor (e.g., Microsoft Word) 402. In order to create instructions 403, the creator then adds questions or option choices to the template (including tooltips, actions, logic, mapped fields, defaults, and the like) 404. Next, the creator adds sections, placeholders, and bookmarks to the template 406. Subsequently, the creator organizes the wizard flow using, pages, groups, and questions or option choices 408. Following creation of the instructions 403, the creator then tests the template and instructions 410 to ensure proper functionality. Next, the creator exports the final template and instructions 412 to create a useable dynamic document comprising the final template and instructions 414.

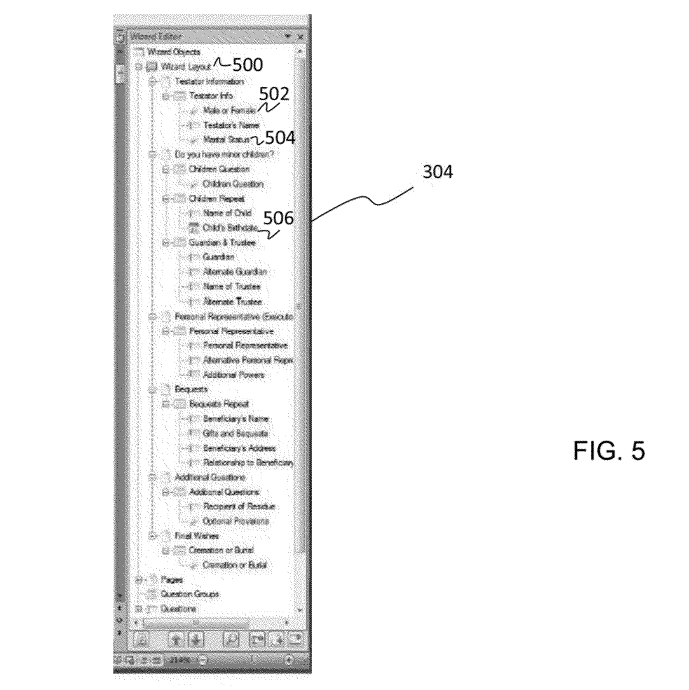

An expanded view of the wizard editor 304 of FIG. 3 is shown in FIG. 5. In this example, a wizard layout 500 is expanded. This item shows at a high level the different types of information that are determined by the creator to be needed to complete the dynamic document, which are laid out in an appropriate hierarchy or tree structure. Each item of data is represented by a name and a graphic indicating the type of information and type of dynamic document item it represents. For example, the testator's name is shown with an icon representing a Text Field. By contrast, a Male or Female item 502 represents an option that will be used to retrieve one or more sections based on the option selected. In this non-limiting example, selecting Male will insert sections (and sub-sections) that use male pronouns as appropriate (e.g., him, he), as well as other sections (and sub-sections) that may be specific to a male testator.

A Marital Status option 504 will also retrieve specific sections (and sub-sections) that are required when the testator is, and/or has been married. Each of these retrieved sections will incorporate its own placeholders for spouse name as appropriate.

Another type of data illustrated in FIG. 5 is date data, as represented by a calendar icon associated with Child's Birthdate 506. When presented with this option, the system may provide a date entry field, a clickable pop-up calendar, or some other means of allowing the easy entry of dates into a document. The creator has the option of selecting from one or more date presentation and selection options when creating the dynamic document.

The system described herein supports many types of data fields, non-limiting examples of which include image upload, multi-select, single select, single line text, multi-line text, phone number, numeric only, currency, state selector, and can be extended to support unlimited new types of data fields. For example, the system can be extended to support business specific data fields, such as Customer Name selector, that will be populated from an external system.

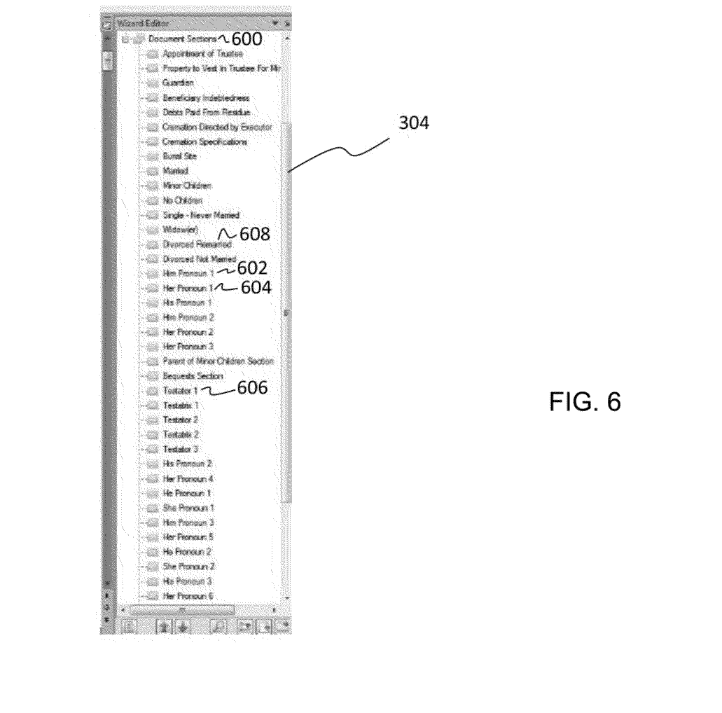

FIG. 6 illustrates the wizard editor 304 when a Document Sections 600 has been expanded. This tracks each section defined by the creator and allows the creator to easily navigate to sections as needed. The sections show a Him Pronoun I section 602 and a Her Pronoun I section 604 that will be selected based on the gender of the testator. A Testator I section 606 and a Divorced Remarried section 608 are shown and correspond to the example shown in FIG. 3.

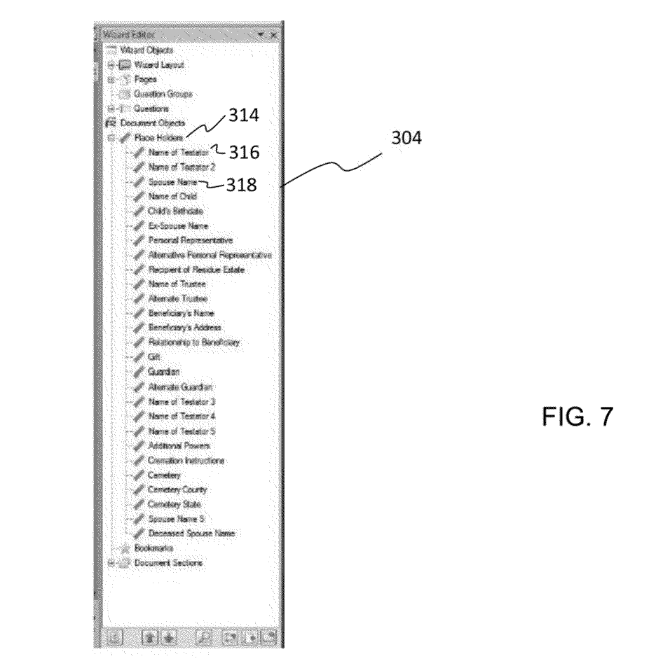

The expansion of the placeholders 316 of the wizard editor 304 is illustrated in FIG. 7. This example shows the Name of Testator Placeholder 314 and the Spouse Name Placeholder 318 of FIG. 3. All placeholders defined in the dynamic document by the creator may be found in this expanded list.

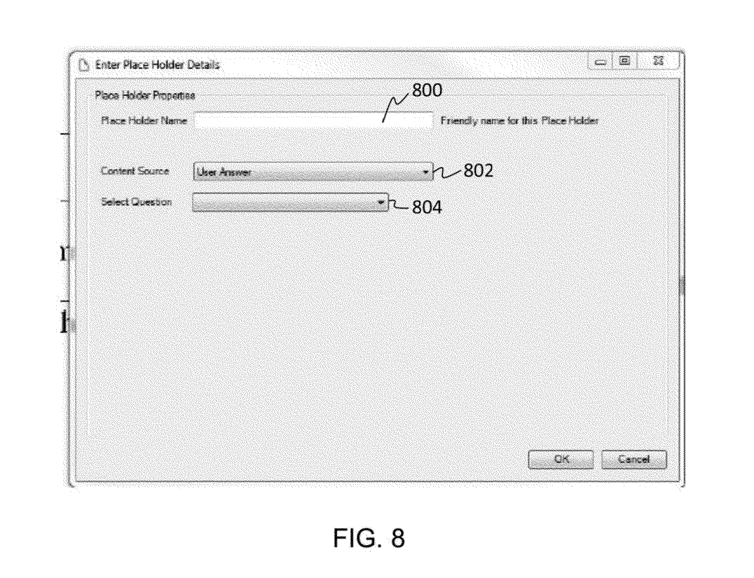

The creation and defining of a placeholder is illustrated in FIG. 8. A dialog box is presented to the creator when the creator elects to enter a placeholder in the dynamic document. The box includes a field 800 to enter a natural language name for the placeholder. This allows the creator to use names for placeholders that make sense. Generally, the end-user will not be able to see the names of the placeholders. A source 802 of the content for the placeholder data is, for example, a drop-down selection menu that allows the creator to determine how the placeholder information is to be requested from the end-user. It may be a menu, option box, or some other manner, but a typical manner is a user answer which is a response to a question or option choice. A selector 804 allows the creator to select from one or more previously defined questions or option choices, or to create a new question or option choice for the placeholder. After a placeholder is defined, the creator can simply drag it or otherwise invoke it in different sections. The system will track all sections and locations in which the placeholder is used and will auto-fill those sections when the user has answered the question or option choice and entered the data.

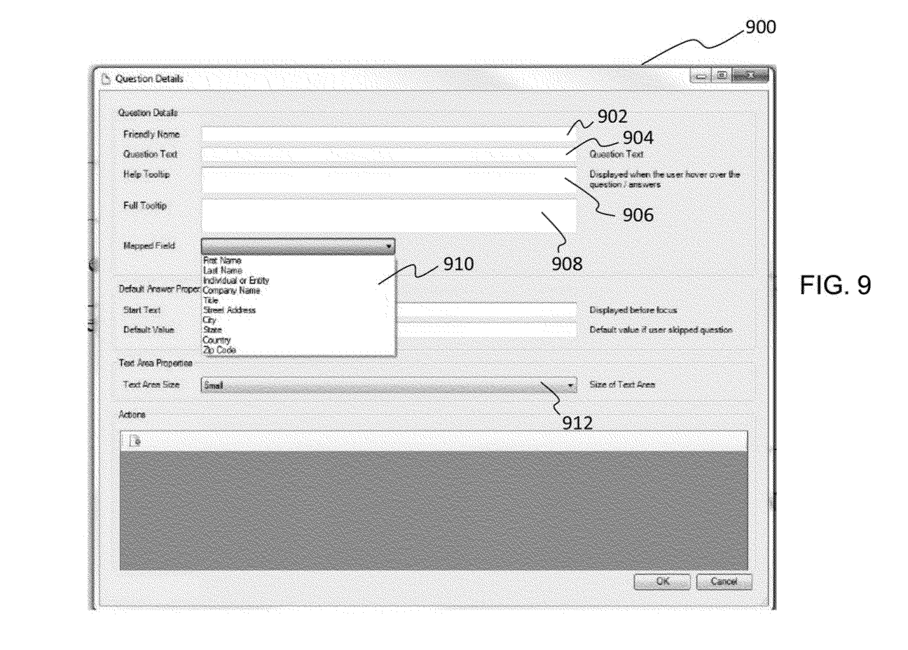

A question or option choice in the system is an important method of collecting data and information from the user. FIG. 9 illustrates a dialog box 900 for defining a question or option choice. The dialog box 900 includes a field 902 (e.g., friendly name) for a creator-chosen name for the question or option choice to allow ease of implementation. The text of the question is entered into a question field 904 (e.g., question text). In one embodiment of the system, the creator can define two or more levels of ToolTips to aid the user in answering questions or selecting option choices, referred to here as a “Help Tooltip” 906 and a “Full ToolTip” 908 where additional tooltips can be added if the creator so desires. The Help Tooltip is typically invoked by the end-user mousing or hovering a cursor over the question or option choice, or by selecting the tooltip indicator next to the question or option choice if the end-user or the creator of the document selected that option (any selection method may be used). At that point the Help Tooltip appears and gives some information about what type of information the question or option choice is looking for. If the end-user needs more information, there is a clickable region where the Full ToolTip 908 can be presented to the end-user, giving more detailed information and instruction.

The type of field presented to the end-user for the question or option choice can be determined by a menu 910, which includes a number of predefined fields (e.g., First Name, Last Name, Address). Selecting one of these controls the type of data field presented to the end-user to complete the question or select the option choice. The text properties of the data can be controlled with a set of tools 917.

Question fields can have Start Text, which is some explanation of what the end-user should enter, such as “enter first name” or “enter phone”, which will help guide the end-user in answering the question or completing the field box. Questions also have a Default Value which, if left unchanged, will be the answer the system will include in the final document. Start Text and Default Value are optional to the document creator.

If the question type is text, the creator can select the size of textbox the user will see. This is important, as sometimes the answer can be short and simple (e.g., “What is your name?”) and sometimes the answer can be very long (e.g., “what is the scope of the project?”). The ability to determine the size of the textbox will help in the usability of the questions and options flow (wizard) and the system overall.

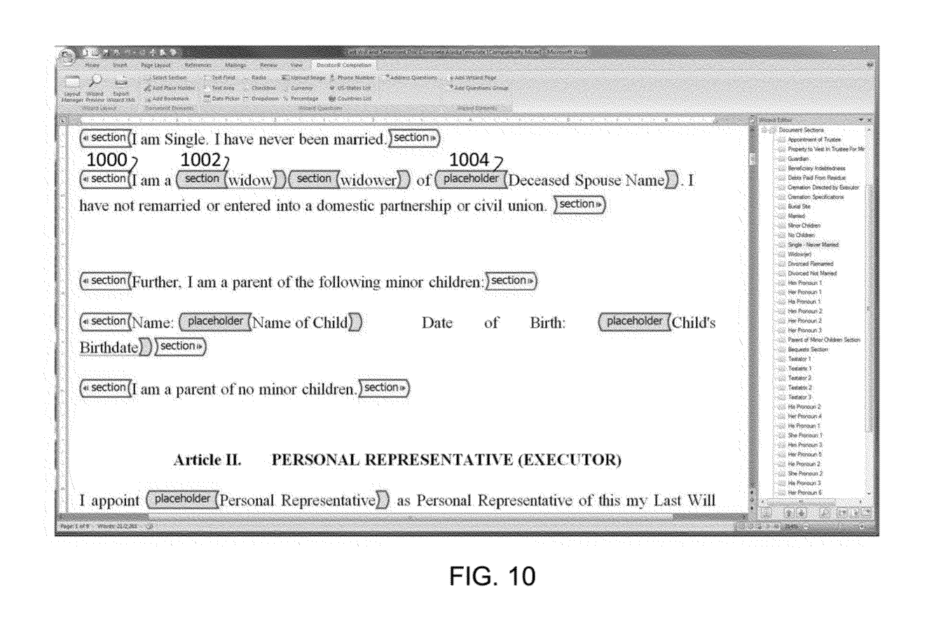

The nesting of sections (i.e., sub-sections) into other sections is shown in FIG. 10. For example, section 1000 includes a nested sub-section 1002 as well as a placeholder 1004. Additionally, placeholders may also have nested placeholders (or sub-placeholders).

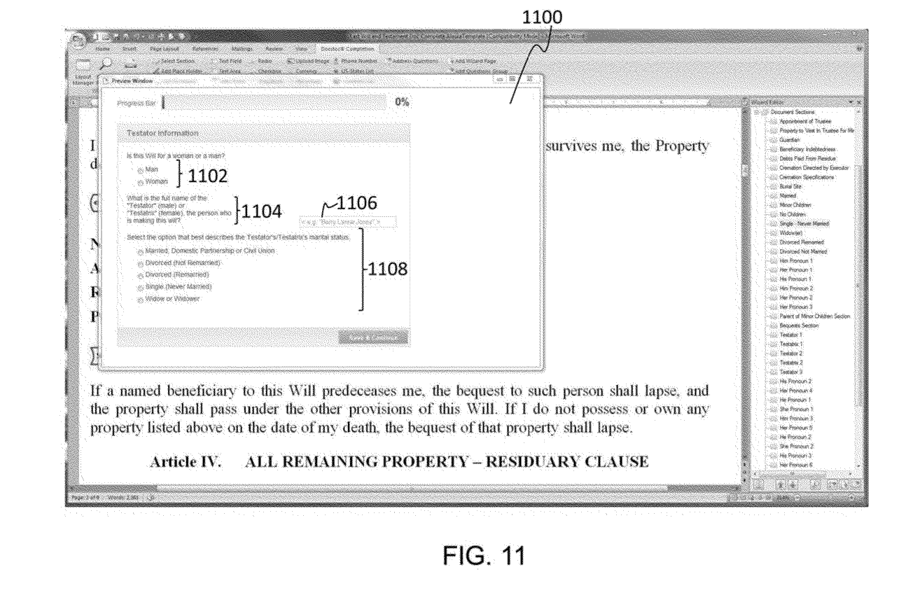

FIG. 11 depicts a preview window 1100 that allows the creator to review questions and options flow that has been defined in progress. In this example, the preview window 1100 shows information needed for the testator. A gender 1102 is determined by selecting an option between Man or Woman. Making this selection will automatically trigger the selection of certain sections related to gender, as well as gender pronoun choices.

A question that has been defined by the creator and requests the Name of the Testator is depicted by element 1104 which, when completed in a field 1106, will become the data of a placeholder and be populated throughout sections selected by the system. A marital option 1108 allows the end-user to indicate marital status from a list of presented options.

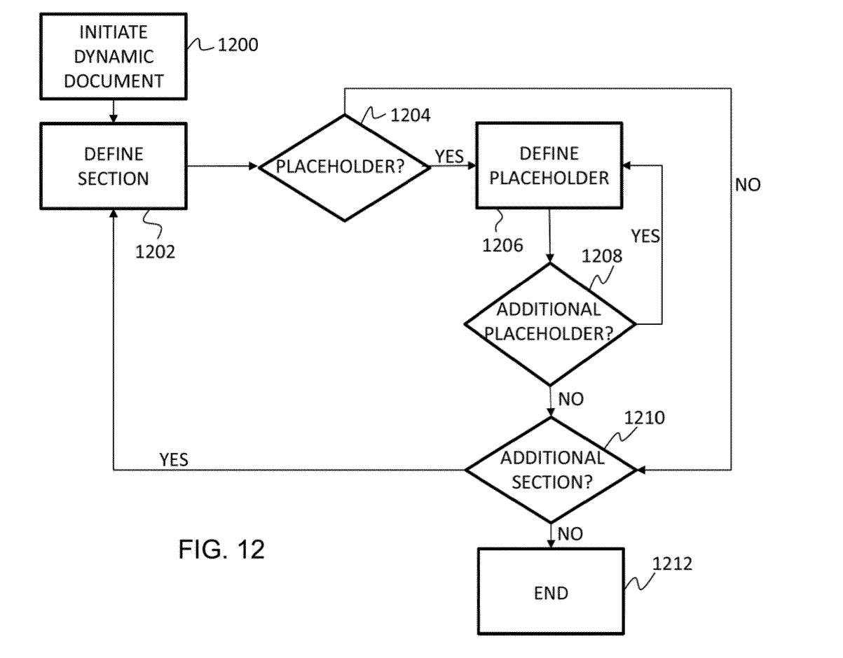

A flow diagram illustrating the operation of a simple document creation in one aspect of the system is presented in FIG. 12. The creator first initiates a dynamic document 1200. Next, the creator defines a section 1202. This is accomplished by entering the appropriate text of the section, naming the section, and the like. At decision block 1204 it is determined whether the section requires a placeholder. If so, the system defines the placeholder 1206. This may be accomplished by creating a new placeholder or by invoking a previously created placeholder. At decision block 1208, it is determined whether an additional placeholder is desired in the section. If so, the system defines another placeholder 1206 and returns to decision block 1208.

If there are no additional placeholders determined in decision block 1208, or there is no placeholder from decision block 1204, the system proceeds to decision block 1210 to determine if there is another section to be defined. If so, the system returns to define the new section 1202. If not, the system ends at 1212.

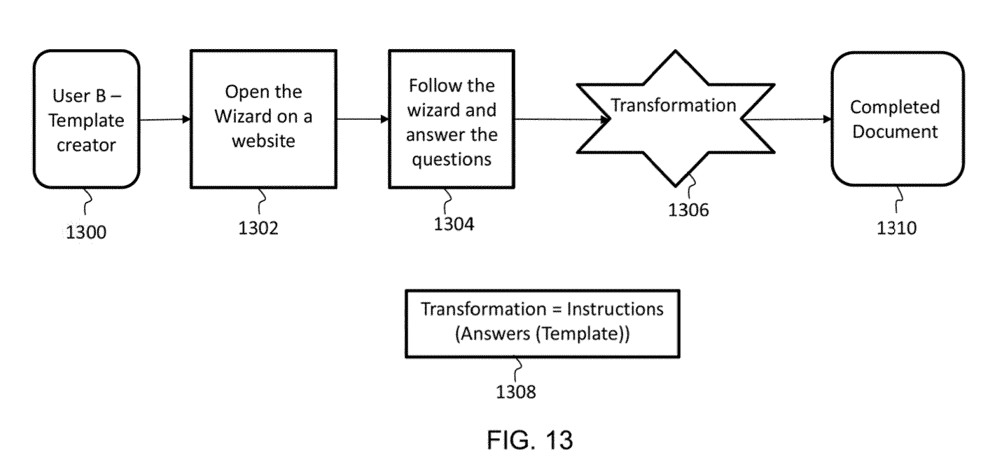

A flow diagram illustrating how an end-user would use a template (i.e., User B—Template) created by an embodiment of the system is shown in FIG. 13. First, the end-user initiates the document completion mode (i.e., template creator) 1300. Next, the system opens a wizard on a browser, application, or the like 1302. The user then follows the instructions of the wizard, answers questions, and provides information as requested by the wizard 1304. Once the information has been received, the system transforms 1306 the answers into a document (using instructions applied to the answers in light of the template at 1308) and creates a completed document 1310.

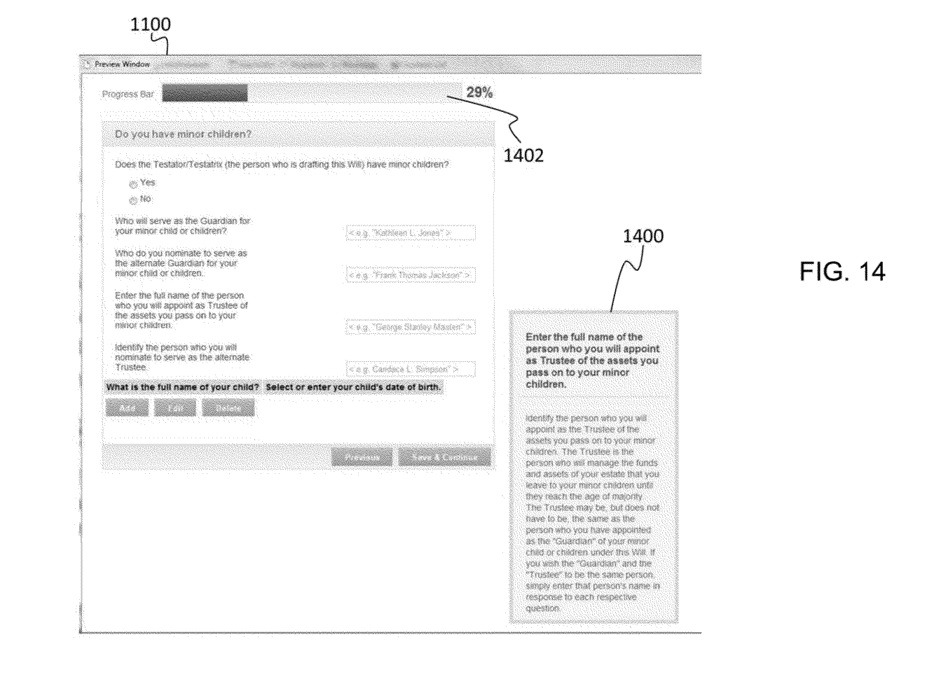

FIG. 14 illustrates a preview window 1100 showing an example of a Help Tooltip 1400. In this example, the Help Tooltip 1400 describes the role of a Trustee for minor children in the event of a parent's death. Therefore, in preparation of a will and testament, the Help Tooltip 1400 assists parents in determining who should act as a Trustee for their minor children in order to best answer the question. Additionally, a progress bar 1402 indicates to the end-user his/her progress in the completion of the document.

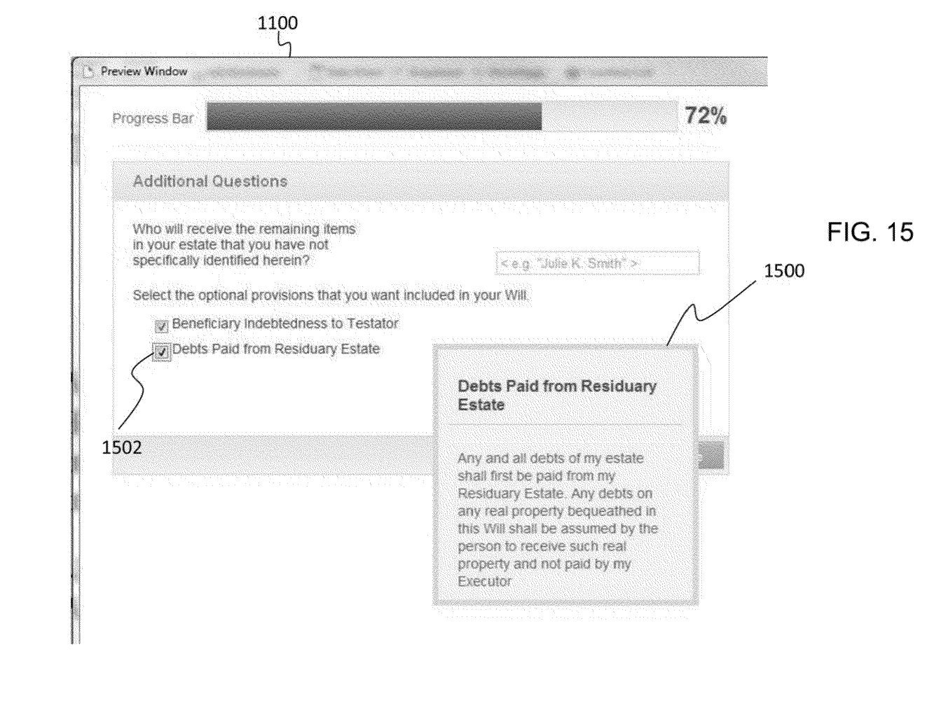

FIG. 15 depicts a preview window 1100 illustrating an example of a Help Tooltip 1500 applied to an answer or option. When the option to include debts paid from residuary estate is selected 1502, the Help Tooltip 1500 provides details with regards to the selection.

While the examples presented have included a legal document (e.g., will and testament), the invention described herein can be applied to other applications as well. As non-limiting examples, the present invention could also be used as part of a tax preparation system, a menu planning program, or a health assessment program. For instance, in the menu planning program example, an end-user could specify the type of meal that he/she would like to prepare, such as breakfast, lunch, or dinner. Examples of question/option categories may include serving size, dietary restrictions (e.g., vegetarian, gluten-free), cooking experience level of end-user, and cooking times. From the answers and selections of the end-user, a customized recipe (or set of recipes) can be generated along with, for example, a shopping list of ingredients to purchase that tits the particular needs of the end-user.

Furthermore, the invention can be used to generate multimedia files. For instance, a customized workout plan can be created by providing questions regarding what type of workout is desired (e.g., running, yoga, strength training), the level of intensity (e.g., beginner, advance), the duration, and the form of media (e.g., audio, text, video). Based on the end-users responses to the questions, video files can be spliced together to generate a customized workout plan that the end-user can view, listen to, or read instructions for. In this example application, the Help Tooltips can provide helpful tips to an end-user that are customized to the type of the workout or to the level of intensity. For example, an end-user that is a beginner in yoga may need to see a video file or hear a detailed explanation of a particular pose while an end-user that has advanced yoga skills may be interested in tips related to advancing a pose to achieve a deeper stretch.

What is claimed is:

1. A method for creating customized documents comprising acts of:
providing a document template where the document template includes a place holder and a section bolder:
providing a directional graph with nodes for collecting information from an end-user, where the information collected is related to the place holder and section holder of the document template for creating a customized document;
collecting information from an end-user; and
using a transformation engine for merging information collected from an end-user with the document template to create a customized document.

2. A method as set forth in claim 1, where the nodes of the graph are generated to perform logical actions in response to information collected from the end-user.

3. A method as set forth in Claim 2, where the logical actions are selected from a group consisting of filling place holders, adding sections, removing sections, presenting further information queries, modifying a user interaction level, providing recommendations to the end-user, providing tips to the end-user, providing information to the end-user, and presenting the end-user with a transaction opportunity.

4 A method as set forth in claim 3, where the further information is selected from a group consisting of detailed descriptions, questions, and options, and is in a format selected from a group consisting of text, audio, and video.

5. A method as set forth in claim 1, further comprising an act of storing a set of information collected from the end-user and mapping the information to another directional graph for merging with another document template; whereby the efficiency, accuracy, and consistency of a user's creation of customized documents is enhanced.

6. A method as set forth in claim 1, where information is collected from multiple end-users and is merged with the document template to create a collaborative customized document.

7. A method as set forth in claim 6, further comprising an act of providing an administrative end-user with an ability to grant access privileges, where the administrative end-user determines a degree of access fur other end-users.

8. A method as set forth in claim 7, where end-users may communicate with other end users by providing comments accessible to other end users.

9. A method as set forth in claim 8, where the degree of access for other end-users is determined by limiting the other end-user's access to portions of the document template, portions of the directional graph, what information is collected from the other end-user, contextual information presented to the other end-user, and comments from other end-users.

10. A method as set forth in claim 1, further comprising an act of, based on a portion of the information collected from the end-user, determining a complexity level for collecting other information from the end-user.

11. A method as set forth in claim 10, wherein the complexity level for collecting other information from the end user is determined in a manner selected from a group consisting of explicit selection of the complexity level by the end-user, automatic selection of the complexity level based on information collected from the end-user, and explicit selection of the complexity level by another end-user.

12. A method as set forth in claim 1, wherein at least one of the place holder and section holder of the document template contains another place holder or section holder.

13. A method as set forth in claim 1, further comprising an act of storing a set of information collected from the end-user as a user profile and mapping the information from the user profile to the directional graph for merging the document template; whereby the efficiency, accuracy, and consistency of a user's creation of customized documents is enhanced.

14 A method as set forth in claim 1, wherein the transformation engine is configured to merge the information collected from the end-user with multiple document templates to create multiple customized documents.

15. A method as set forth in claim 1, wherein the document template is a multimedia document template and where the customized document is a multimedia document.

16. A method as set forth in claim 15, further comprising an act of, based on a portion of the information collected from the end-user, determining a complexity level for the customized document.

17. A method as set forth in claim 15, wherein the transformation engine is configured to merge the information collected from the end-user with multiple document templates to create multiple customized documents.

18. A method as set forth in claim 1, further comprising an act of, based on a portion of the information collected from the end-user, determining a complexity level for the customized document, and where the end-user can toggle between various levels of complexity.

19. A system for creating customized documents, the system comprising a processor and a memory coupled with the processor, wherein the memory includes instructions that are executable by the processor for causing the processor to perform operations of:
providing a document template where the document template includes information holders represented by a place holder and a section holder;
providing a directional graph with nodes for collecting information from an end-user, where the information collected is related to the place holder and section holder of the document template for creating a customized document;
collecting information from an end-user; and
using a transformation engine for merging information collected from an end-user with the document template to create a customized document.

20. A computer program product for creating customized documents, the computer program product comprising computer-readable instructions stored on a computer-readable medium that are executable by a computer having a processor for causing the processor to perform the operations of:
providing a document template where the document template includes information holders represented by a place holder and a section holder;
providing a directional graph with nodes for collecting information from an end-user, where the information collected is related to the place holder and sec lion holder of the document template for creating a customized document;
collecting information from an end-user; and
using a transformation engine for merging information collected from an end-user with the document template to create a customized document.
